(19) United States
(12) Patent Application Publication
(10) Pub. No.: US 2010/0281290 A1
(43) Pub. Date: Nov. 4, 2010

(54) CLOCK GENERATING CIRCUIT OF COMPUTER

(75) Inventor: Ke-You Hu, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (Shenzhen) CO., LTD, Shenzhen City (CN); HON HAI PRECISION INDUSTRY CO., LTD., Tu-Cheng (TW)

(21) Appl. No.: 12/482,394

(22) Filed: Jun. 10, 2009

(30) Foreign Application Priority Data
Apr. 30, 2009 (CN) 200910301995.4

(51) Int. Cl. G06F 1/04

(52) U.S. Cl. 713/503

(57) ABSTRACT

A clock signal generating circuit of a computer includes a first phase locked loop (PLL) circuit and a second PLL circuit. The computer includes a central processing unit (CPU) and a data bus. The first PLL provides a CPU clock signal to the CPU. A frequency of the CPU clock signal is the same as a working frequency of the CPU. The second PLL circuit provides a bus clock signal to the data bus. A frequency of bus clock signal is the same as a working frequency of the data bus. The data bus is to communicate with a graphic chip. The CPU clock signal is to control a working speed of the CPU. The bus clock signal is to control a working speed of the data bus.

### BACKGROUND

1. Technical Field

The present disclosure relates to clock generators, and more particularly to a clock signal generating circuit of a computer.

2. Description of Related Art

Clock generators in computer motherboards of computers are used to provide required clock frequencies to control speeds of computer components, such as main processers, system buses, and various interfaces. Performance of the computers may be influenced if the clock generators are improperly designed. For example, when a Bitland X1550 graphic card works with an Intel E4400 central processing unit in a computer, no image can be displayed, this problem is caused by a deficiently designed clock generator of the computer.

### BRIEF DESCRIPTION OF THE DRAWINGS

FIG. 1 is a block diagram of an embodiment of a clock generating circuit of a computer.

FIG. 2 is a wave diagram of a clock signal of a computer graphic chip of the computer of FIG. 1, without utilizing the clock generating circuit.

### DETAILED DESCRIPTION

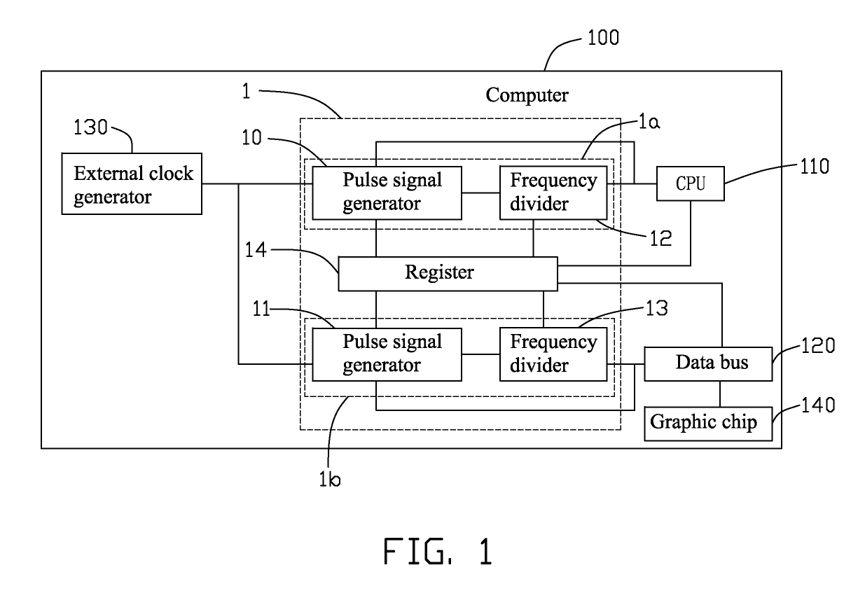

Referring to FIG. 1, an embodiment of a clock generating circuit 1 is to provide clock signals to components of a computer 100, such as a central processing unit (CPU) 110 and a data bus 120 of the computer 100. The embodiment of the clock generating circuit 1 includes two phase-locked loop (PLL) circuits 1a, 1b, and a register 14. The PLL circuit 1a includes a pulse signal generator 10, and a frequency divider 12 connected between the pulse signal generator 10 and the CPU 110. The PLL circuit 1b includes a pulse signal generator 11, and a frequency divider 13 connected between the pulse signal generator 11 and the data bus 120. The register 14 is connected to the pulse signal generators 10, 11, the frequency dividers 12, 13, the CPU 110, and the data bus 120.

The pulse signal generators 10, 11 are operable to receive an external clock signal from an external clock generator 130 of the computer 100, and output first and second pulse signals according to the external clock signal. A frequency of each of the first and second pulse signals is an integer multiple of a frequency of the external clock signal. The frequency divider 12 is to output a CPU clock signal by dividing the frequency of the first pulse signal. The frequency divider 13 is to output a bus clock signal by dividing the frequency of the second pulse signal. The CPU clock signal is to control a working speed of the CPU 110 by adjusting a working frequency of the CPU 110. The bus clock signal is to control a working speed of the CPU 110 by adjusting a working frequency of the data bus 120. The working frequencies of the CPU 110 and the data bus 120 are respectively fed back to the pulse signal generators 10, 11 by the register 14.

The pulse signal generator 10 compares the frequency of the CPU clock signal and the working frequency of the CPU 110, and changes the frequency of the first pulse signal, according to a difference between the frequency of the CPU clock signal and the working frequency of the CPU 110. In this embodiment, in order to make the CPU 110 work steadily, the frequency of the CPU clock signal is adjusted to be the same as the working frequency of the CPU 110. Similarly, the frequency of the bus clock signal is adjusted to be the same as the working frequency of the data bus 120, according to a difference between the frequency of the bus clock signal and the working frequency of the data bus 120.

In this embodiment, each of the frequency dividers 12 and 13 may be a divide-by-N counter, to reduce a signal frequency by dividing the signal frequency by an integer N. The register 14 is to store parameters of the dividers 12 and 13, such as a value of the integer N of each of the dividers 12 and 13. The data bus 120 is a peripheral component interconnect-express (PCI-E) bus. The computer 100 communicates with a graphic chip 140 via the data bus 120.

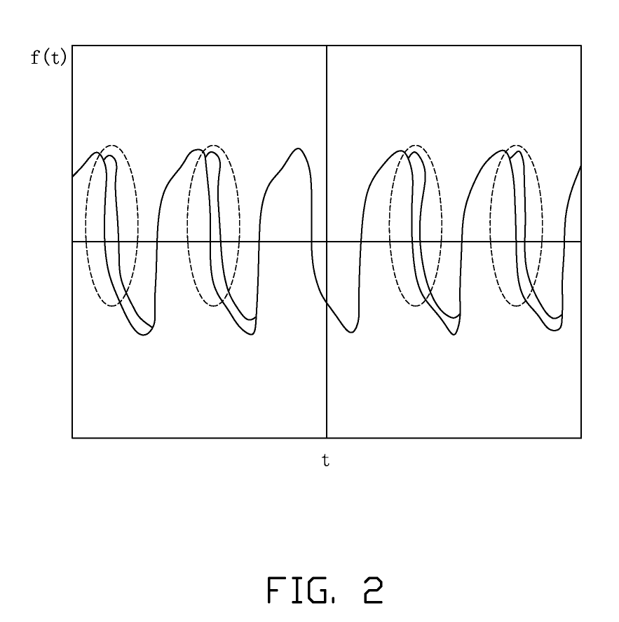

Referring to FIG. 2, a wave diagram of a clock signal f(t) of the graphic chip 140 is obtained by simulation, which is generated by an ordinary clock generator instead of the clock generating circuit 1. The simulation result shows that there is noise generated during variation of the clock signal f(t) with time t. In this figure, the noise is denoted by broken circles. In this condition, the graphic chip 140 may output abnormal graphic signals caused by the noise of the clock signal f(t) of the graphic chip 140.

Interference between the CPU 110 and the data bus 120 may be avoided by providing a single PLL circuit for each of the CPU 110 and the data bus 120 as in the clock generating circuit 1. Therefore, the noise of the clock signal f(t) of the graphic chip 140 is avoided, and the computer 100 can normally display images via the graphic chip 140.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A clock signal generating circuit of a computer that comprises a central processing unit (CPU) and a data bus, the clock signal generating circuit comprising:
a first phase locked loop (PLL) circuit to provide a CPU clock signal to the CPU in response to receipt of an external clock signal, and adjust a frequency of the CPU clock signal to be the same as a working frequency of the CPU; and
a second PLL circuit to provide a bus clock signal to the data bus in response to receipt of the external clock signal, and adjust a frequency of the bus clock signal to be the same as a working frequency of the data bus.

2. The circuit of claim 1, wherein each of the first and second PLL circuits comprises a pulse signal generator operable to output a pulse signal having a frequency being an integer multiple of a frequency of the external clock signal.

3. The circuit of claim 2, wherein each of the first and second PLL circuits further comprises a frequency divider, and each of the CPU clock signal and the bus clock signal is outputted by dividing the frequency of the corresponding pulse signal by the corresponding frequency divider.

4. The circuit of claim 3, wherein the frequency dividers are to feed the frequencies of the CPU clock signal and the bus clock signal back to the pulse signal generators correspondingly.

5. The circuit of claim 2, further comprising a register to feed the working frequency of each of the CPU and the data bus to the corresponding pulse signal generator.

6. The circuit of claim 1, wherein the frequency of the CPU clock signal is adjusted according to a difference between the frequency of the CPU clock signal and the working frequency of the CPU, the frequency of the bus clock signal is adjusted according to a difference between the frequency of the bus clock signal and the working frequency of the data bus.

7. A clock signal generating circuit of a computer, comprising:
a first phase locked loop (PLL) circuit to provide a CPU clock signal having a frequency being the same as a working frequency of a center processing unit (CPU) of the computer, wherein the CPU clock signal is to control a working speed of the CPU; and
a second PLL circuit to provide a bus clock signal to a data bus communicating with a graphic chip of the computer, the bus clock signal having a frequency being the same as a working frequency of the data bus, wherein the bus clock signal is to control a working speed of the data bus.

8. The circuit of claim 7, wherein the data bus is a peripheral component interconnect-express bus.

9. A computer system comprising:
a computer comprising a center processing unit (CPU), and a data bus communicating with the CPU and a graphic chip;
a first phase locked loop (PLL) circuit to output a CPU clock signal to control a working speed of the CPU according to a difference between the frequency of the CPU clock signal and the working frequency of the CPU fed back to the first PLL circuit; and
a second PLL circuit to output a bus clock signal to control a working speed of the data bus according to a difference between the frequency of the bus clock signal and the working frequency of the data bus fed back to the second PLL circuit.
